(19) United States
(12) Patent Application Publication
(10) Pub. No.: US 2026/0225375 A1
(43) Pub. Date: Aug. 6, 2026

(54) IMAGE FORMING APPARATUS AND CONTROL METHOD OF THE SAME

(71) Applicant: Konica Minolta, Inc., Tokyo (JP)

(72) Inventor: Masahiro MATSUO, Tokyo (JP)

(21) Appl. No.: 19/400,488

(22) Filed: Nov. 25, 2025

(30) Foreign Application Priority Data
Feb. 5, 2025 (JP) 2025-017927

(51) Int. Cl. B41J 2/20; B01F 35/21; B01F 35/213; B01F 35/22; B41J 2/175; B41J 2/21; B41J 29/377; G01K 1/02; G01K 3/00; B01F 101/35

(52) U.S. Cl. CPC B41J 2/20; B01F 35/2112; B01F 35/2115; B01F 35/213; B01F 35/2209; B41J 2/17566; B41J 2/2117; B41J 29/377; G01K 1/026; G01K 3/005; B01F 2101/35

(57) ABSTRACT

The image forming apparatus includes: an ink tank that stores ink to be delivered to an inkjet head; a stirrer that stirs the ink in the ink tank; and a stirring controller that controls the stirrer to stir the ink with stirring settings based on a state of the ink in the ink tank.

### CROSS-REFERENCE TO RELATED APPLICATION

This application claims the benefit of priority to Japanese Patent Application No. 2025-017927 filed on 5 February 2025, the disclosures of all of which are hereby incorporated by reference in their entireties.

### TECHNICAL FIELD

The present invention relates to an image forming apparatus and a control method of the same.

### BACKGROUND OF THE INVENTION

Some inkjet-based image forming apparatuses include a sub-tank having a small capacity near an inkjet head, in addition to an ink tank having a large capacity. The ink in the ink tank is delivered to the sub-tank by an ink delivery pump or the like. Then, the ink in the sub-tank is adjusted to a predetermined viscosity or the like by heating or the like, and is ejected from the inkjet head. In such an image forming apparatus, when the ink in the ink tank is gelated, forming images may have a failure due to increase in viscosity of the ink or a reduction in amount of the delivered ink. To cope with this, Japanese patent application publication No. 2019-142044 (hereinbelow, referred to as Patent Literature 1), for example, discloses an image forming apparatus that occasionally stirs ink in an ink tank and delivers the ink to a sub-tank. Japanese patent application publication No. 2009-179015 (hereinbelow, referred to as Patent Literature 2) discloses an image recording apparatus that stirs ink by vibrating a piezoelectric member in order to prevent the ink in an ink chamber of a nozzle from increasing in viscosity.

### SUMMARY OF THE INVENTION

### Problems to be Solved

As with the image forming apparatus of Patent Literature 1, stirring settings such as the rotational speed, stirring time, and frequency of stirring ink in the ink tank can be determined in advance. Ink delivery settings such as the capability of the ink delivery pump and the ink delivery time can also be determined in advance. However, a load on a motor to stir the ink in the ink tank and an amount of ink delivered per unit time by the ink delivery pump vary depending on viscosity of the ink in the ink tank. Patent Literature 2 describes that the intensity of stirring is determined on the basis of a standing time during which stirring is not executed, but the stirring is executed in vicinity to the nozzle and is not intended for an ink tank having a large capacity.

The viscosity of the ink in the ink tank varies not only with the standing time of the ink but also with the temperature of the ink, the formulation of the ink, the type of the ink, and the like. When the ink has high viscosity, there can be problems of poor ink delivery, failure of a motor due to increase in load at the time of stirring, and poor image quality due to the ink itself not being homogenized. The present invention has been devised in order to solve the above-identified problems, and is intended to provide an image forming apparatus that changes settings for stirring and delivering ink, based on a state of ink in an ink tank to achieve stabilization of stirring and deliveing ink, and a control method of the same.

### Solution to Problems

In order to solve the above-identified problems, an image forming apparatus has the following configuration. An image forming apparatus includes: an ink tank that stores ink to be delivered to an inkjet head; a stirrer that stirs the ink in the ink tank; and a stirring controller that controls the stirrer to stir the ink with stirring settings based on a state of the ink in the ink tank.

### BRIEF DESCRIPTION OF DRAWINGS

The advantages and features provided by one or more embodiments of the present invention can be fully understood from the detailed description given hereinbelow and the appended drawings which are given by way of illustration only and thus are not intended to define the limits of the present invention, in which:

FIG. 1 shows a schematic diagram of an example arrangement of units of an image forming apparatus according to an embodiment;

FIG. 2 is a block diagram of an example hardware configuration of the image forming apparatus according to the embodiment;

FIG. 3 is a schematic diagram of example devices and pathes for supplying ink;

FIG. 4 is a block diagram of an example functional configuration of an ink supply control unit according to an embodiment;

FIG. 5A is a chart of example change in load on a stirring motor by ink temperature;

FIG. 5B is a chart of example change in load on the stirring motor by ink volume;

FIG. 5C is a chart of example change in load by setting of a rotational speed of the stirring motor;

FIG. 5D is an example relationship between ink color and load on the stirring motor;

FIG. 6 is an example flowchart of a process of changing stirring settings, when an ink temperature is detected;

FIG. 7 is an example flowchart of a process of setting default stirring settings;

FIG. 8 is an example flowchart of a process of detecting an ink temperature and changing stirring settings only for the first stirring immediately after activation;

FIG. 9 is an example flowchart of a process of calculating a standing time and changing stirring settings only for the first stirring immediately after activation;

FIG. 10 is an example flowchart of a process of changing stirring settings, when an ink level in an ink tank is detected;

FIG. 11 is an example flowchart of a process of changing stirring settings, when a stirring torque is detected;

FIG. 12 is an example flowchart of a process of changing ink delivery settings, when an ink temperature is detected with a main thermometer; and

FIG. 13 is an example flowchart of a process of setting default ink delivery settings.

### DETAILED DESCRIPTION

Hereinafter, embodiments of the present invention are described with reference to the drawings. Note that the present invention is not limited to the embodiments and modifications, and can be changed variously in design. Additionally, the embodiments and modifications can be combined with one another as appropriate. The expressions of directions including up, down, right, and left in the description are merely examples of a relative positional relationship, and do not limit the directions in use. In addition, when some members are not shown in one or more drawings, the size, shape, and positional relationship of the members may be exaggerated.

### First Embodiment

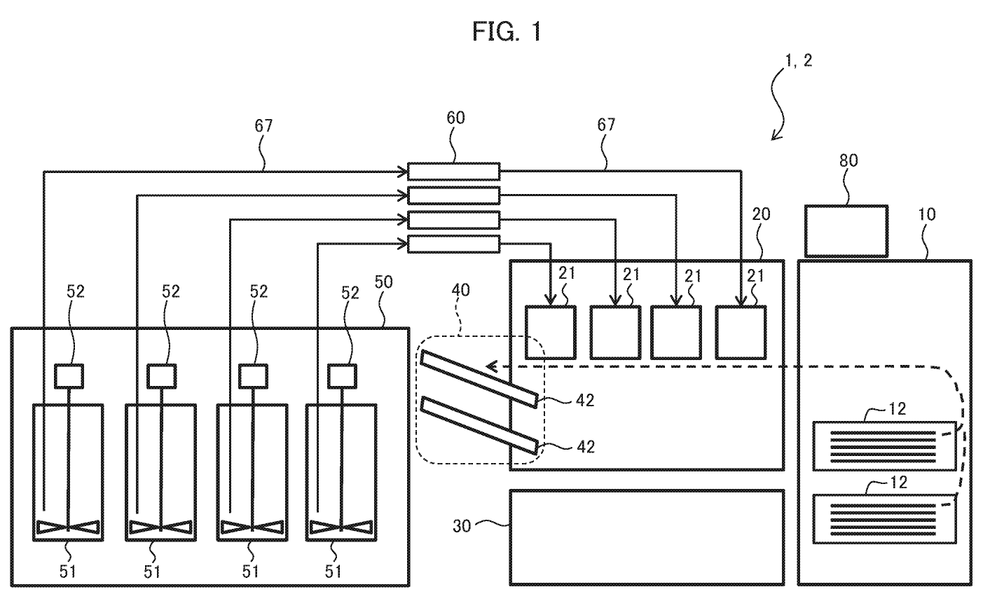

An image forming apparatus 1 according to a first embodiment is described, with reference to FIGS. 1 to 5D. The image forming apparatus 1 is an inkjet-based image forming apparatus that forms images on a recording medium by ejecting ink from nozzles of an inkjet head. As shown in FIG. 1, the image forming apparatus 1 includes a feed unit 10, an output unit 40, an operation unit 80, an image forming unit 20, a reservoir 50, an ink delivery unit 60, and a control unit 30. Hereinbelow, configurations of the image forming apparatus 1 are described.

### Feed Unit and Output Unit

The feed unit 10 is a device that stores one or more recording media, on which images are formed, and feeds the recording media one by one toward the image forming unit 20. The feed unit 10 has feed trays 12, and can sort and store the recording media. The recording media may be made of paper, cloth, resin, or the like. The output unit 40 is a device that outputs and stores one or more recording media on which images have been formed. The output unit 40 can sort and output the recording media to output trays 42. Note that FIG. 1 shows the case of using discrete sheets cut to a predetermined size, but the feed unit 10 and output unit 40 can be used for a roll-shaped recording medium.

### Operation Unit

The operation unit 80 is a device with which the image forming apparatus 1 is operated and settings are input therefor. The operation unit 80 can display information such as an operation status of the image forming apparatus 1. The operation unit 80 may be a touch screen, for example. The point where the operation unit 80 is provided is not particularly limited, and the operation unit 80 may be provided at a point away from the image forming unit 20 and the like. In addition, the operation unit 80 may be an external terminal such as a personal computer.

### Image Forming Unit

The image forming unit 20 is a device that forms images on a conveyed recording medium. The image forming unit 20 can have ejection parts 21. Here, the image forming unit 20 has four ejection parts 21 which are respectively used for cyan (C), magenta (M), yellow (Y), and black (K), for example. The number of ejection parts 21 is not particularly limited, and the ink colors are not particularly limited either. The image formation method may be a scanning method in which an inkjet head reciprocates or a single pass method in which an inkjet head is fixed.

### Ejection Part

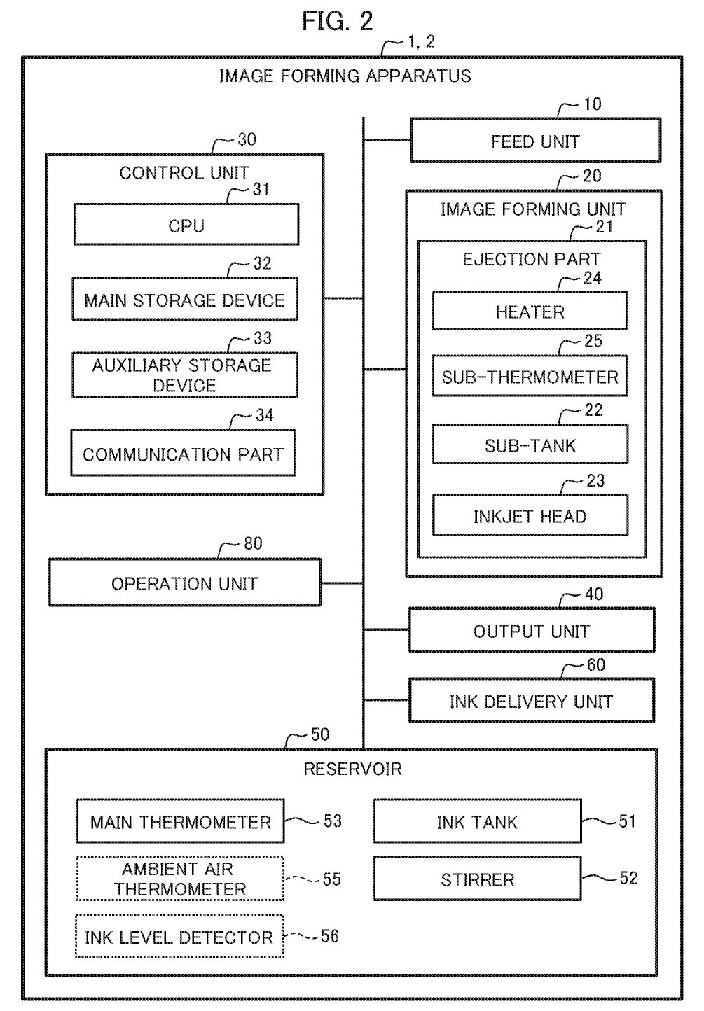

The ejection part 21 is a device that transiently stores ink before being ejected and ejects the ink toward a recording medium. As shown in FIG. 2, the ejection part 21 includes an inkjet head 23, a sub-tank 22, a heater 24, and a sub-thermometer 25. The inkjet head 23 is a device that ejects droplets of ink from a nozzle. The inkjet head 23 can eject the ink supplied from the sub-tank 22 by utilising deformation of a piezoelectric element, for example.

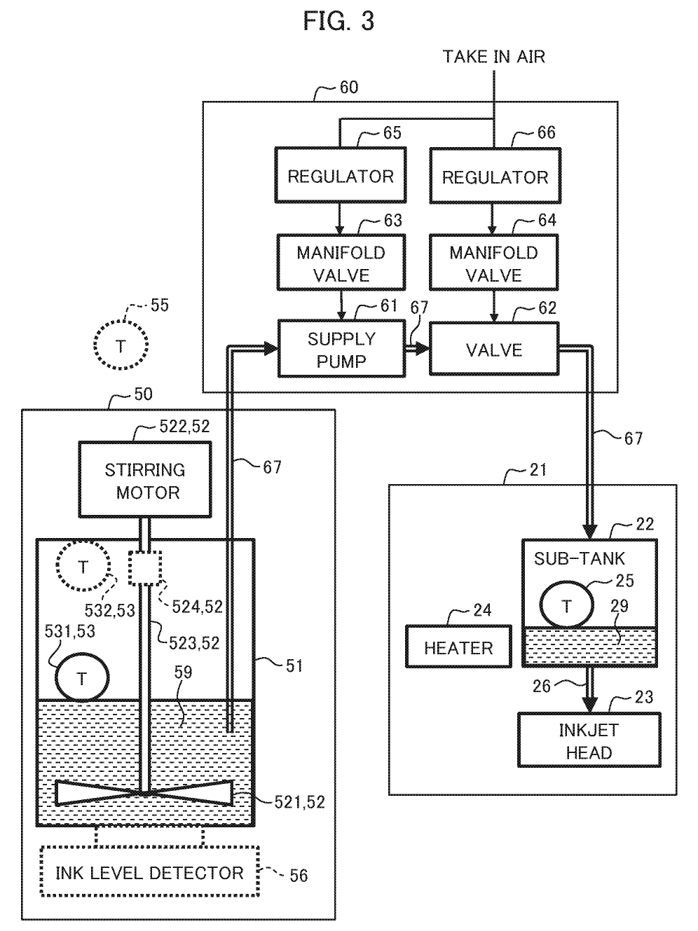

The sub-tank 22 is a container that is provided on the downstream side of an ink tank 51 and stores the ink delivered from the ink tank 51. The ink in the sub-tank 22 is heated by the heater 24 and maintained at a predetermined temperature suitable for ejection. The heater 24 is a heater and is controlled by the control unit 30. The sub-thermometer 25 is a device that detects a temperature of the ink in the sub-tank 22. Here, the sub-thermometer 25 is provided inside the sub-tank 22, but may be provided in vicinity to the outside of the sub-tank 22. Supplying ink to the sub-tank 22 is executed by the reservoir 50 and ink delivery unit 60, as shown in FIG. 3.

### Reservoir

The reservoir 50 is a device that stores and manages ink. The reservoir 50 includes the ink tank 51, a stirrer 52, and a main thermometer 53. The ink tank 51 is a container to store ink and can contain 30 L of ink, for example. The ink tank 51 stores ink to be delivered to the inkjet head 23. Here, the reservoir 50 has the four ink tanks 51, but the ink tanks 51 are not particularly limited in number.

The stirrer 52 is a device that stirs the ink in the ink tank 51. The stirrer 52 rotates a stirring screw 521 in the ink tank 51 by a stirring motor 522 to stir ink 59. Here, the stirring screw 521 is connected to the stirring motor 522 via a rotation shaft 523. The stirring motor 522 is an electric motor and is controlled by the control unit 30. The control unit 30 can acquire information on the stirring motor 522, such as a rotational speed. The ink 59 can be a phase-change ink. The phase-change ink is an ink that undergoes a phase change between a sol with fluidity and a gel without fluidity. The phase-change temperature is 80°C, for example, and when the temperature of the ink decreases, the ink increases in viscosity to turn into a gel. The phase-change ink, when ejected in the sol state from the inkjet head 23, turns into a gel on the landed recording medium, to allow for forming images in high quality. Note that the phase-change ink even in a gel can be delivered by a general pump, when mechanically sheared through stirring.

The main thermometer 53 is a device that detects a temperature of the ink in the ink tank 51. The main thermometer 53 is provided inside the ink tank 51. Here, the main thermometer 53 is a contact-type thermometer 531 that contacts the ink 59 to measure the temperature of the ink.

### Ink Delivery Unit

The ink delivery unit 60 is a device that delivers ink from the ink tank 51 to the inkjet head 23. Here, the ink delivery unit 60 is provided in each of the four ink tanks 51 and delivers the ink from the ink tank 51 to the sub-tank 22. The ink is sequentially supplied from the sub-tank 22 to the inkjet head 23 via a supply path 26 in accordance with the amount of ejected ink. As shown in FIG. 3, the ink delivery unit 60 includes a supply pump 61, a valve 62, manifold valves 63 and 64, and regulators 65 and 66. The supply pump 61 and valve 62 are provided on a path to supply ink. The ink tank 51, supply pump 61, valve 62, and sub-tank 22 are provided in this order on the path to supply ink, and connected to each other via ink delivery tubes 67. Note that FIG. 3 shows a path to supply ink to the single ejection part 21. When there are a number of the ejection parts 21, the ink tanks 51 for the respective ejection parts 21 can be provided, together with a number of paths to supply ink.

The supply pump 61 is a pump that transports ink. The valve 62 is a check valve. The supply pump 61 and valve 62 are air-driven here, but may be electrically driven. The regulators 65 and 66 are devices that take in and compress ambient air (air) to generate compressed air at a predetermined air pressure. The regulators 65 and 66 are controlled by the control unit 30 to set the air pressure. The manifold valves 63 and 64 are devices that divert and deliver the compressed air to the supply pump 61 and valve 62, respectively. Opening and closing of the manifold valves 63 and 64 are controlled by the control unit 30. The regulators 65 and 66 and the manifold valves 63 and 64 can be shared by a number of ink supply paths.

### Control Unit

The control unit 30 is a device that controls devices of the image forming apparatus 1. The control unit 30 controls the entire image forming apparatus 1, inclusive of feeding sheet, forming images, outputting, supplying ink, and the like of the image forming apparatus 1. As shown in FIG. 2, the control unit 30 includes a CPU 31 as a central processing unit, a main storage device 32, an auxiliary storage device 33, and a communication part 34. These are connected to each other via a bus, and further connected to devices of the image forming apparatus 1.

The CPU 31 is a processing device that executes various programs. The main storage device 32 is a RAM (Random Access Memory), for example, and temporarily stores various kinds of data processed by the CPU31 in execution. Additionally, the main storage device 32 transitorily stores programs for activating the devices. The auxiliary storage device 33 may be a hard disk , a solid state drive (SSD), or the like and stores program for controlling the devices by the CPU 31, information on functions processed by the devices, print data received from the communication part 34, and the like. The communication part 34 is a network interface card responsible for communication with the outside. The communication part 34 is connected to a network via a local area network (LAN) or the like, and is capable of transmitting and receiving data to and from an external client computer or the like.

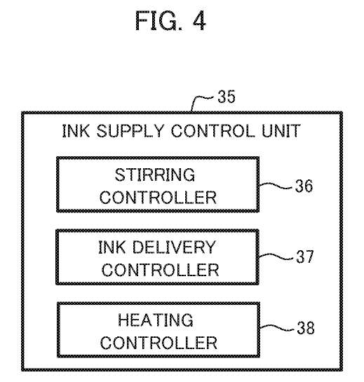

The control unit 30 causes a conveyance unit (not shown) to convey a recording medium from the specific feed tray 12 of the feed unit 10 to the image forming unit 20, to form images. In forming images, the control unit 30 generates bitmap data of colors of cyan, magenta, yellow, and black (CMYK) for printing from the print data and send the data to the image forming unit 20. Then, the control unit 30 controls the inkjet head of the image forming unit 20 to form images on the recording medium, and causes the recording medium to be conveyed and output to the output tray 42. In addition, the control unit 30 controls supplying ink from the reservoir 50 to the ejection part 21. Supplying ink is controlled by an ink supply control unit 35 as a means to control supplying ink. As shown in FIG. 4, the ink supply control unit 35 includes a stirring controller 36, an ink delivery controller 37, and a heating controller 38.

The ink delivery controller 37 is a means to control ink delivery from the ink tank 51 to the ejection part 21. The ink delivery controller 37 controls devices of the ink delivery unit 60. The heating controller 38 is a means to control heating ink. The heating controller 38 is capable of controlling the heater 24 of the ejection part 21 to maintain the temperature of the ink in the sub-tank 22 within a predetermined range.

The stirring controller 36 is a means to control the stirrer 52. The stirring controller 36 controls the stirrer 52 to stir the ink with stirring settings based on the state of the ink in the ink tank 51. The state of the ink refers to an amount, a property, a situation, and the like that affect stirring and delivering the ink, and particularly refers to viscosity of the ink in this case. The viscosity varies depending on the temperature of the ink and ink level in the ink tank 51, and the time that has elapsed without the ink being stirred (hereinbelow, may be referred to as "standing time”), and the like. The viscosity, as a state of ink, also varies depending on the formulation and color of ink. Here, the temperature of the ink is detected as an indicator of the state of the ink in the ink tank 51. The stirring controller 36 changes stirring settings when the temperature of ink in the ink tank 51 is at or below a predetermined threshold value.

In determining the temperature, it is preferable to determine that the temperature is at or below a predetermined threshold value when the detected temperature is at or below the predetermined threshold value for a predetermined time, for example. The stirring settings are preferably changed when the detected temperature is at or below a predetermined threshold value for a predetermined time. In this manner, the stirring controller 36 can reduce the influence of an accidental detection error or the like. The same applies to other embodiments and modifications. The predetermined time in detecting the temperature corresponds to the frequency of continuous detection, when detecting the temperature is executed at constant time intervals. For example, when detecting the temperature is repeated at a frequency of once every 10 seconds and the predetermined time is set to one minute, the stirring controller 36 determines that the temperature is at or below the predetermined threshold value over one minute as the predetermined time, when the values at or below the predetermined threshold value have been detected seven times continuously, and changes the stirring settings.

The stirring settings are settings of a rotational speed and a stirring time of stirring by the stirrer 52. The rotational speed of stirring is a rotational speed of the stirring screw 521, that is, the number of rotations of the stirring screw 521 per unit time. The stirring time is a time during which the stirring motor 522 is continuously driven. As the stirring settings, a time interval at which the stirring is repeated with the rotational speed and the stirring time can also be set. Changing the stirring settings means tentatively changing the stirring settings set through default setting or the like as normal stirring settings. The normal stirring settings are those inherited from the previous operation or set through default setting when the image forming apparatus 1 is activated. That is, the stirring controller 36 changes settings from the normal stirring settings to those suitable for ink having high viscosity due to decrease in temperature, for example, when the temperature of ink in the ink tank 51 is at or below a predetermined threshold value for a predetermined time. Changing the stirring settings can be specified such that the changed settings are restored to the normal stirring settings after the stirring with the changed stirring settings has been executed once, with continuous stirring for the length of the stirring time counted as one stirring. Note that changing the stirring settings may be specified such that the changed settings are restored to the normal stirring settings after stirring with the changed stirring settings has been executed a number of times.

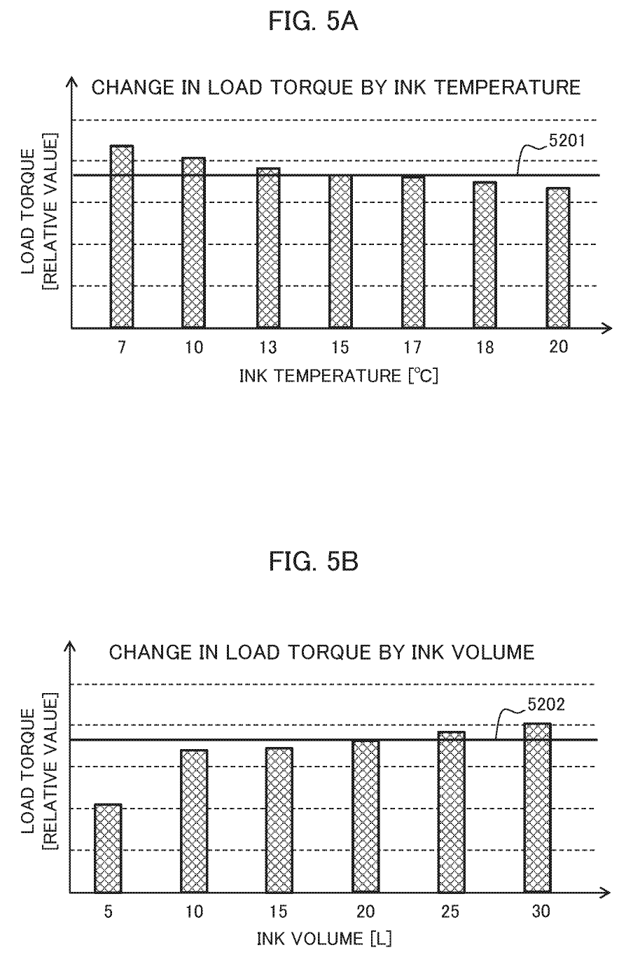

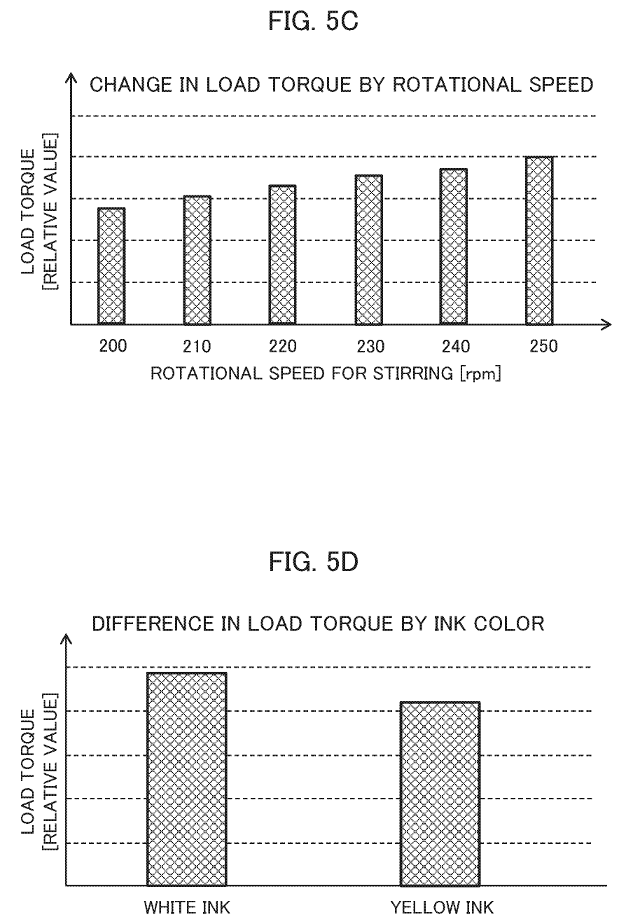

As shown in FIG. 5A, when the temperature decreases, the viscosity of the ink increases to have the load on the stirring motor 522 of the stirrer 52 increased. Increase in the load on the stirring motor 522 may cause the image forming apparatus 1 to stop due to detection of abnormality or the stirring motor 522 to fail. In such a case, changing the stirring settings to decrease the rotational speed of the stirring motor 522 allows for preventing the image forming apparatus 1 from stopping due to detection of abnormality and preventing the stirring motor 522 from failing. The predetermined threshold value of the ink temperature can be set to 80% of the rated value of a load torque of the stirring motor 522 as a rough standard, for example. A guideline 5201 in FIG. 5A indicates a load torque at 80% of the rated value, as an example. The load torque reaches 80% of the rated value at 15°C, based on FIG. 5A, so that the threshold value of the ink temperature can be set to 15°C.

As shown in FIG. 5C, increasing the rotational speed of the stirring motor 522 increases the load torque of the stirring motor 522. Then, when the ink temperature is below the threshold value, the rotational speed of the stirring motor 522 may be decreased in changing the stirring settings, to decrease the load torque of the stirring motor 522. According to FIG. 5C, the load torque at the rotational speed of 240 rpm becomes 83% at the rotational speed of 210 rpm and 75% at the rotational speed of 200 rpm. The rotational speed of the stirring motor 522 can be changed based on these pieces of data. However, when the rotational speed of the stirring motor 522 is decreased, the ink in the ink tank 51 may not be sufficiently stirred. Particularly, at the time of the first activation in the morning, the ink in the ink tank 51 has wax thereof separated therefrom and the temperature of the ink is low, so that the ink is liable to fail to be sufficiently stirred if the rotational speed of the stirring motor 522 is simply decreased. Thus, extending the stirring time allows for sufficiently stirring the ink in the ink tank 51. That is, when the rotational speed of the stirring motor 522 is decreased, it is preferable to extend the stirring time additionally. Note that extending the stirring time is preferably set in consideration of decrease in productivity due to inability to start the next processing.

In addition, excessive stirring, that is, stirring with the rotational speed of the stirring motor 522 being too high or stirring with the stirring time being too long causes a problem such that the ink foams to generate air bubbles in the ink. The image forming apparatus 1 executes deaeration in the ejection part 21, after the ink has been delivered from the ink tank 51. The air bubbles in the ink may affect this deaeration, to cause deterioration in quality of forming images. Accordingly, it is preferable that the stirring settings be set to suitable ones for preventing generation of air bubble, that is, settings in consideration of a balance between the rotational speed of the stirring motor 522 and the stirring time. For example, when the ink has high viscosity, the stirring settings may be set such that the rotational speed of the stirring motor 522 is decreased to reduce the load on the stirring motor 522, and the stirring time is increased to homogenize the ink, within a range of generation of air bubbles being negligible.

The image forming apparatus 1 having the above-described configuration focuses on the temperature of the ink as an indicator of the state of the ink in the ink tank and changes the settings for stirring the ink, to allow for stably stirring and delivering the ink regardless of the state of the ink, with the ink stirred homogeneously while the stirring motor being prevented from failing due to increase in load. This prevents any errors in forming images due to insufficient stirring and/or delivering of the ink, to improve quality of forming images. The image forming apparatus 1 decreases the rotational speed of stirring and increases the stirring time in response to increase in the load of stirring due to decrease in the temperature of ink in the ink tank, to stably stir and deliver the ink.

Note that the main thermometer 53 may be a non-contact thermometer 532 that measures the temperature of the ink without contacting the ink 59. When the non-contact thermometer 532 is used, it is preferable to install the thermometer at a height not to catch splash of the ink. The splash of the ink may be caused by replenishing the ink tank 51 with the ink or stirring the ink by the stirrer 52.

### Modifications

Next, modifications of the image forming apparatus 1 are described. A first modification is one in which ambient air temperature is detected as an indicator of the state of the ink. The first modification has an ambient air thermometer 55 that detects the ambient air temperature, and the stirring controller 36 changes the stirring settings based on the ambient air temperature. When the ambient air temperature is at or below a predetermined temperature, the stirring controller 36 can determine that the temperature of ink in the ink tank 51 has been decreased. The stirring controller 36 may change the stirring settings when the ambient air temperature is at or below a predetermined threshold value, or may change the stirring settings when the ambient air temperature has been at or below a predetermined threshold value for a predetermined time.

The ambient air thermometer 55 is a device that detects an ambient air temperature, and can be provided on an outer surface of the feed unit 10 of the image forming apparatus 1, for example. The ambient air thermometer 55 may be provided away from the image forming apparatus 1. In the case of the first modification, the main thermometer 53 may not be provided. Having no main thermometer 53 allows for preventing the one or more sensors in the ink tank 51 from being damaged or erroneously detecting values.

A second modification is one in which the temperature of the ink in the sub-tank 22 is detected as an indicator of the state of the ink. The stirring controller 36 of the second modification changes the stirring settings based on the temperature of the ink in the sub-tank 22. The sub-tank 22 includes the sub-thermometer 25 that is provided on a downstream side of the ink tank 51 and detects the temperature of the ink. The second modification changes stirring settings when the temperature of the ink in the sub-tank 22 is at or below a predetermined threshold value or when the temperature is at or below the predetermined threshold value for a predetermined time. The ejection part 21 is provided with the sub-thermometer 25 to detect the temperature of the ink in the sub-tank 22. The heater 24 to heat the ink in the sub-tank 22 is also provided for the sub-tank22. However, the sub-tank 22 is not heated by the heater 24 after the image forming apparatus 1 has stopped its operation. Accordingly, the temperature of ink in the sub-tank 22 decreases due to the ambient temperature, as with the temperature of ink in the ink tank 51. Then, when the temperature of the ink in the sub-tank 22 is at or below a predetermined temperature at the time of activation, the stirring controller 36 determines that the temperature of the ink in the ink tank 51 has decreased so that stirring is required to deal with high viscosity.

A third modification is one in which an ink level in the ink tank 51 is detected as an indicator of the state of ink. The third modification includes an ink level detector 56 that detects an ink level of the ink tank 51. Then, the stirring controller 36 changes stirring settings based on the ink level of the ink tank 51. The ink level detector 56 is a device that detects the ink level of the ink tank 51. The ink level may be detected from a weight including the ink tank 51, or from a height of the liquid level of the ink 59 in the ink tank 51, for example. When detecting the ink level from the height of the liquid level, the ink level detector 56 is provided inside the ink tank 51.

As shown in FIG. 5B, when the ink volume is large, the viscosity of the ink increases to increase the load for the stirrer 52. Accordingly, the third modification changes stirring settings when the ink level is greater than a predetermined threshold value. The predetermined threshold value can be set to 80% of the rated load torque of the stirring motor 522 as a rough standard, as with the ink temperature. A guideline 5202 in FIG. 5B indicates a load torque at 80% of the rated torque, as an example. The load torque reaches 80% of the rated torque at the ink volume of 20 L based on FIG. 5B, so that the stirring settings may be changed when the ink level exceeds 20 L. The stirring settings are preferably changed such that the rotational speed is decreased to prevent the stirrer 52 from failing or the like, and the stirring time is extended to stir the ink homogeneously.

A fourth modification is one in which the color of the ink in the ink tank 51 is acquired as an indicator of the state of the ink. The stirring controller 36 of the fourth modification changes stirring settings based on the color of the ink in the ink tank 51. The fourth modification is capable of setting the stirring settings separately for the respective ink tanks 51. Normal stirring settings common to the ink tanks 51 are set in the image forming apparatus 1. However, ink has different specific gravity and viscosity depending on the color. The fourth modification allows for setting, separately for the respective ink tanks 51, whether or not to change stirring settings from the normal ones, based on the ink color. Note, however, that changing stirring settings with the fourth modification takes effect not limited to once or a number of times, and the changed stirring settings are repeatedly used for stirring unbounded number of times.

The stirring settings can be changed by acquiring ink color information on the respective ink tanks 51 as default setting of the stirring settings at the time of activation, for example. The default stirring settings are maintained until different settings are set as default ones. The ink color information is input by a user at the time of placing the ink tank 51, and is updated by the user at the time of replacing the ink tank 51 or the like. The ink color information is maintained in the control unit 30. For an ink color requiring change in stirring settings, based on the acquired color information, the stirring controller 36 changes the stirring settings for the subject ink tank 51, . Note that when the stirring settings are not changed, the normal stirring settings are maintained.

As shown in FIG. 5D, the load torque for the white ink is larger than that for the yellow ink by 17%. However, the difference in the load torque is small between the inks other than the white ink. Accordingly, the stirring controller 36, when the color of the ink in the ink tank 51 is white, preferably sets the different stirring settings from those when the color is other than white. The fourth modification allows for setting suitable stirring settings based on the ink color, particularly for the ink tank 51 with the white ink.

A fifth modification is one in which the stirring torque is detected as an indicator of the state of the ink. The stirring controller 36 of the fifth modification changes stirring settings based on the torque with which the stirrer 52 stirs the ink, and controls the stirrer 52 to stir the ink with the stirring settings based on the torque. When the viscosity of the ink in the ink tank 51 increases, the torque for stirring the ink increases. The fifth modification detects the torque of the stirring motor 522 and changes stirring settings when the torque exceeds a predetermined threshold value.

As shown in FIG. 3, the torque can be detected by arranging a torque meter 524 on the rotary shaft 523 of the stirring motor 522. Alternatively, the torque can be detected by acquiring a current value and a rotational speed of the stirring motor 522 and then estimating the torque. The torque can be a relative value and may be substituted by a current value or a value of a rotational speed. The predetermined threshold value can be set to 80% of the rated torque of the stirring motor 522, for example, and the stirring settings are changed when the torque exceeds 80% of the rated torque. The stirring settings can be changed to decrease the current value supplied to the stirring motor 522, for example, to decrease the rotational speed. Then, the stirring settings can be changed to extend the stirring time to stir the ink homogeneously.

A sixth modification is one to calculate a standing time, during which the ink has not been stirred, as an indicator of the state of the ink. The stirring controller 36 of the sixth modification changes stirring settings based on the standing time. The sixth modification changes the stirring settings when the standing time exceeds a predetermined length. When the ink in the ink tank 51 stands without being stirred, the temperature may decrease to cause the phase-change ink to turn into a gel, to block the ink from being normally delivered. For this, the stirrer 52 shears the ink by stirring to descrease the viscosity. Also in this case, the stirring settings are preferably changed to decrease the rotational speed to prevent the stirrer 52 from failing, and to extend the stirring time to stir the ink homogeneously.

The ink used in the image forming apparatus 1 may contain wax as an additive. The wax is added for the purpose of increasing the abrasion resistance of the ink adhered to the recording medium, or the like. When the ink stands with no stirring, the wax and components of the ink may be separated from each other due to their specific gravities, to decrease quality of forming images. The layer of separated wax has a higher viscosity than the layer of the ink, especially at a low temperature, to have a problem of high viscosity. For the purpose of homogeneously stirring the ink from which the wax has been separated, it is preferable to decrease the rotational speed and extend the stirring time. Especially, the ink is not stirred for a long time from when the operation of the image forming apparatus 1 is stopped in the evening until the first activation in the morning. The stirring controller 36 can calculate the time from when the operation is stopped until the activation, as a standing time. The sixth modification allows for changing stirring settings, even for the ink added with wax, to those suitable for the state of the ink at the time of the first activation in the morning before stirring. The ink has the wax separated therefrom due to the standing and further has high viscosity due to low temperature. For this, the stirring controller 36 changes stirring settings to decrease the rotational speed and extend the stirring time, to allow for stirring the ink homogeneously, while reducing the load on the stirring motor 522 to prevent any problems, such as failure, from ocurring, to stabilize ink delivery. Note that the stirring time is preferably extended to a duration in which generation of air bubbles in the ink is negligible.

Note that the first embodiment and the modifications allow the stirring controller 36 to change stirring settings for stirring immediately after the activation. The stirring immediately after the activation is the first stirring after the image forming apparatus 1 has been activated. The stirring controller 36 can change stirring settings only for the first stirring after power-on, for example. The ink immediately after activation has high viscosity, when left to stand for a certain period of time, due to thixotropy of the ink, and also has components thereof separated, so that the ink is preferably stirred firmly with suitable stirring settings. Ther stirring controller 36 then continues stirring with the normal stirring settings or the default stirring settings in order to maintain the low viscosity and the homogeneousness.

In addition, two or three, or more, of the first embodiment and the modifications can be combined with each other. For example, the stirring controller 36 may detect the ink temperature with both the main thermometer 53 and the sub-thermometer 25 and change stirring settings when either one of the temperatures is at or below a threshold value. The threshold values of the main thermometer 53 and sub-thermometer 25 can be set to different values from each other. Further, detection of an ambient air temperature may be combined with the above-described detection of the ink temperature.

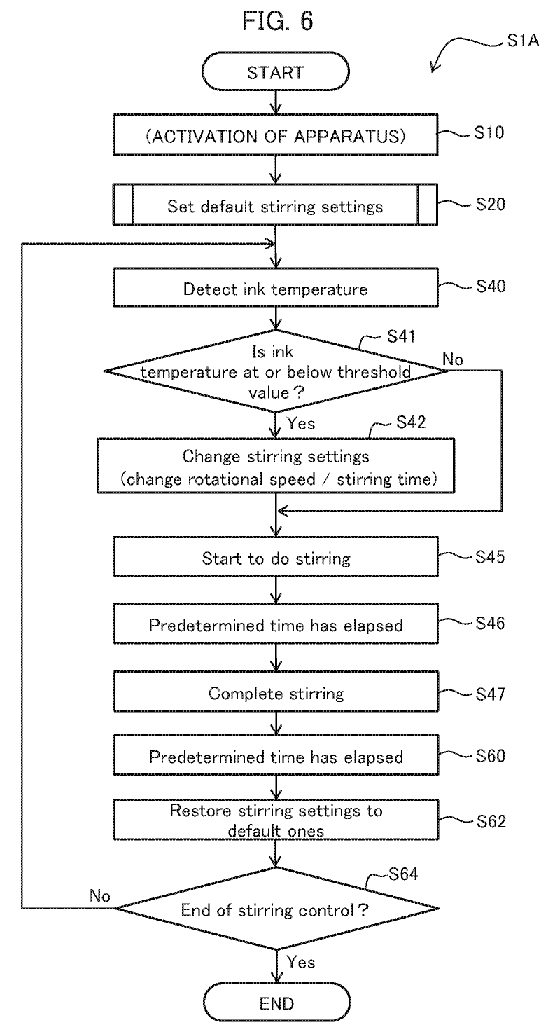

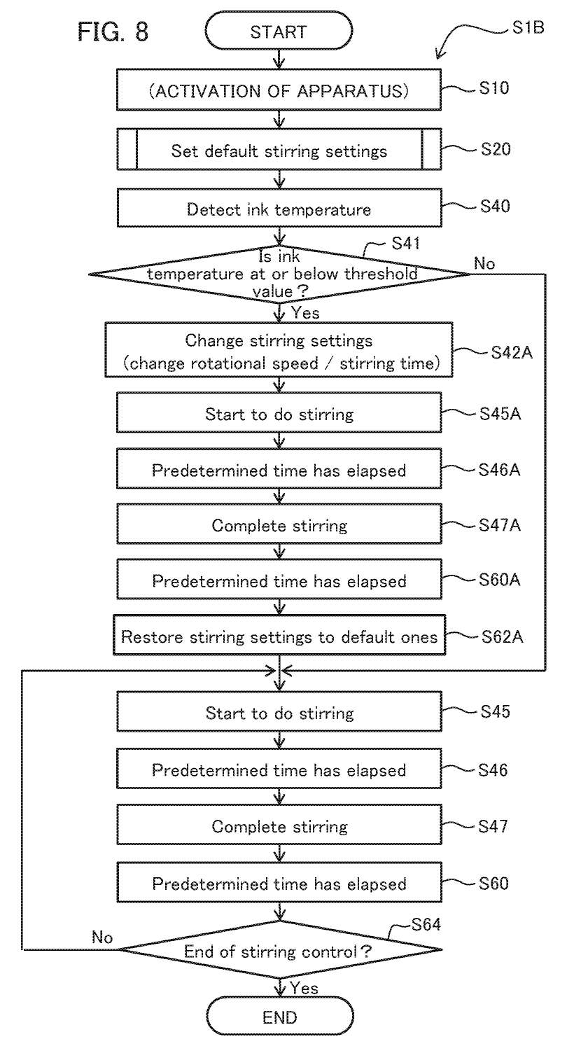

Next, a description is given of a flowchart S1A of a process of stirring the ink in the ink tank 51 of the image forming apparatus 1 according to the first embodiment, with reference to FIG. 6. First, when the image forming apparatus 1 is activated (step S10), the stirring controller 36 sets default stirring settings (step S20). Step S20 is described below. Note that step S20 can be skipped and when skipped, the default settings at the time of the last operation is inherited. The same applies to the flowcharts in FIG. 8 and subsequent drawings.

Then, the stirring controller 36 detects the temperature of the ink in the ink tank 51, with the main thermometer 53 (step S40). When the temperature of the ink is at or below the threshold value (Yes in step S41), the stirring controller 36 changes stirring settings (step S42) and starts to do stirring (step S45). Note that the stirring settings are the rotational speed of stirring and/or the stirring time. When the temperature of the ink exceeds the threshold value (No in step S41), the stirring controller 36 does not change stirring settings and starts to do stirring with the default stirring settings (step S45). Note that when it is determined whether the temperature of the ink is at or below the threshold value (step S41), it is preferable to determine whether the temperature of the ink is at or below the threshold value for a predetermined time.

The stirring controller 36 executes stirring with the changed stirring settings or the default stirring settings, and when a predetermined stirring time has elapsed (step S46), restores the stirring settings to the default ones (step S62). When the stirring control is to be continued (No in step S64), processing returns to detecting the temperature of the ink in step S40 and repeats processing. When the stirring control is to be ended (Yes in step S64), the process in FIG. 6 ends. Noe that the flowchart S1A in FIG. 6 is common to the first modification to detect the ambient air temperature, with the ambient air thermometer 55, and the second modification to detect the temperature of the ink in the sub-tank 22, with the sub-thermometer 25.

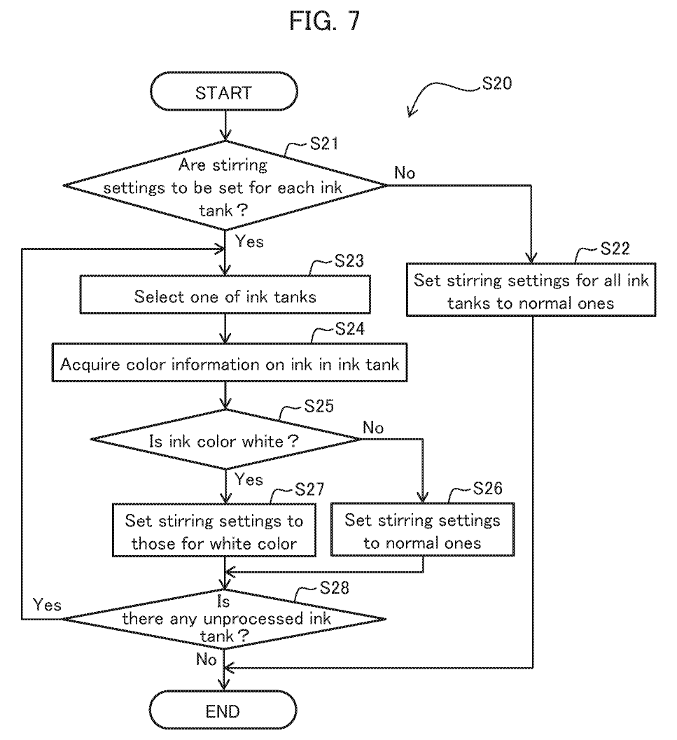

Next, a description is given of a flowchart of a process of setting default stirring settings (step S20), with reference to FIG. 7. FIG. 7 corresponds to the fourth modification, and shows an example process of changing stirring settings when the ink color is white and using the normal stirring settings for the other colors. First, the stirring controller 36 checks whether to set stirring settings for each ink tank, and when not setting stirring settings for each ink tank (No in step S21), sets stirring settings for all ink tanks to normal ones (step S22) and ends the process in FIG. 7.

When setting stirring settings for each ink tank (Yes in step S21), the stirring controller 36 selects one of the ink tanks 51 (step S23) and acquires color information on the ink in the ink tank 51 (step S24). The stirring controller 36 sets stirring settings to those for white color (step S27) when the ink color is white (Yes in step S25), and sets stirring settings to the normal stirring settings (step S26) when the ink color is other than white (No in step S25). The stirring controller 36 repeats the processing until there is no more unprocessed ink tank 51 (step S28) and ends the process in FIG. 7.

Next, a description is given of a flowchart S1B of a process of changing stirring settings for stirring immediately after activation in the first embodiment, with reference to FIG. 8. In the flowchart S1B, the stirring controller 36 changes stirring settings for the first stirring after activation, based on the detected temperature, and thereafter executes stirring with the default stirring settings. As in the flowchart S1A in FIG. 6, when the image forming apparatus 1 is activated (step S10), the stirring controller 36 sets default stirring settings (step S20).

Subsequently, the stirring controller 36 detects the temperature of the ink in the ink tank 51, with the main thermometer 53 (step S40). When the temperature of the ink is at or below the threshold value (Yes in step S41), the stirring controller 36 changes stirring settings (step S42A) and starts the first stirring (step S45A). The stirring controller 36 ends the first stirring (step S47A) after the predetermined stirring time has elapsed (step S46), and starts to do stirring (step S45) with the default stirring settings (step S62A) after the predetermined time, set as the time interval until the second stirring, has elapsed (step S60A). Next, the stirring controller 36 completes the stirring (step S47) after a predetermined time corresponding to the stirring time has elapsed (step S46). After a predetermined time, set as a time interval until the next stirring, has elapsed (step S60), the stirring controller 36 returns to and repeats a step of starting to do stirring with the default stirring settings (step S45) when continuing the stirring control (No in step S64). The stirring controller 36 ends the process in FIG. 8 when ending the stirring control (Yes in step S64).

When the temperature of the ink exceeds the threshold value (No in step S41), the stirring controller 36 does not change stirring settings and starts to do stirring with the default stirring settings (step S45). Then, the stirring controller 36 returns to a step of starting to do stirring (step S45) and repeats stirring with the default stirring settings, until the stirring control is completed (Yes in step S64). In the flowchart S1B in FIG. 8, when the temperature of the ink immediately after the activation is at or below the threshold value, the stirring controller 36 changes stirring settings only for the first stirring, and uses the default stirring settings for the second and subsequent stirring. In addition, when the temperature of the ink immediately after the activation exceeds the threshold value, the stirring controller 36 executes stirring with the default stirring settings from the first stirring, without changing stirring settings.

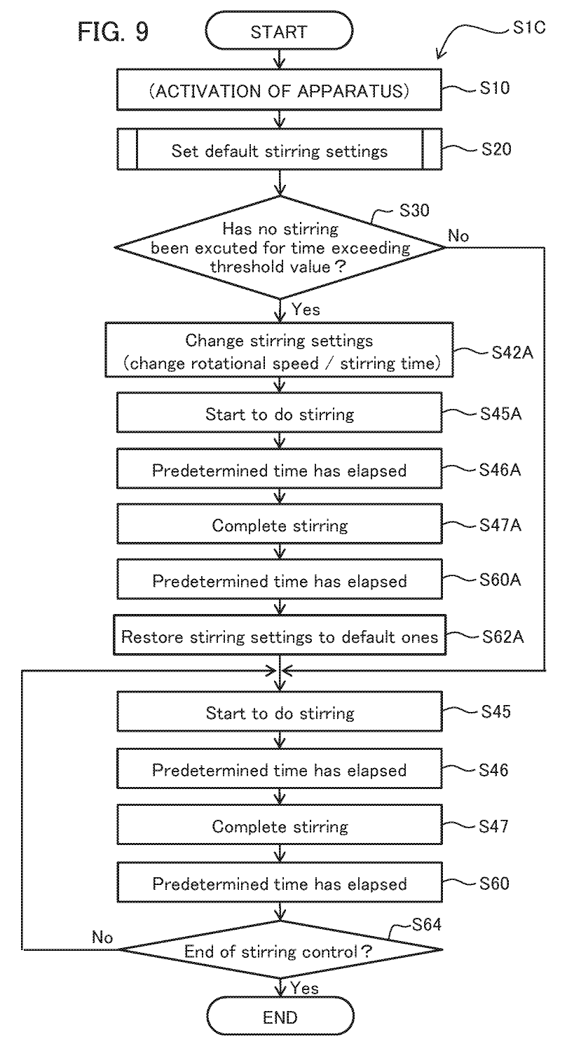

Next, a description is given of a flowchart S1C of a process of detecting a standing time, with reference to FIG. 9. In the flowchart S1C, the stirring controller 36 changes stirring settings for the first stirring after the activation, depending on the standing time, and thereafter executes stirring with the default stirring settings. As in the flowchart S1A in FIG. 6, when the image forming apparatus 1 is activated (step S10), the stirring controller 36 sets stirring settings to the default ones (step S20).

Subsequently, the stirring controller 36 calculates a time from deactivation to reactivation of the image forming apparatus 1, as a time during which no stirring has been executed, that is, a standing time. When the standing time exceeds the threshold value (Yes in step S30), the stirring controller 36 changes stirring settings (step S42A) and starts the first stirring (step S45A). Subsequent processing is the same as that in the flowchart S1B in FIG. 8. When the standing time is less than or equal to the threshold value (No in step S30), the stirring controller 36 does not change stirring settings and starts to do stirring with the default stirring settings (step S45). Thereafter, the stirring controller 36 returns to a step of starting to do stirring (step S45), and repeats stirring with the default stirring settings until the stirring control is completed (Yes in step S64). When the stirring control is completed (Yes in step S64), processing in FIG. 9 ends.

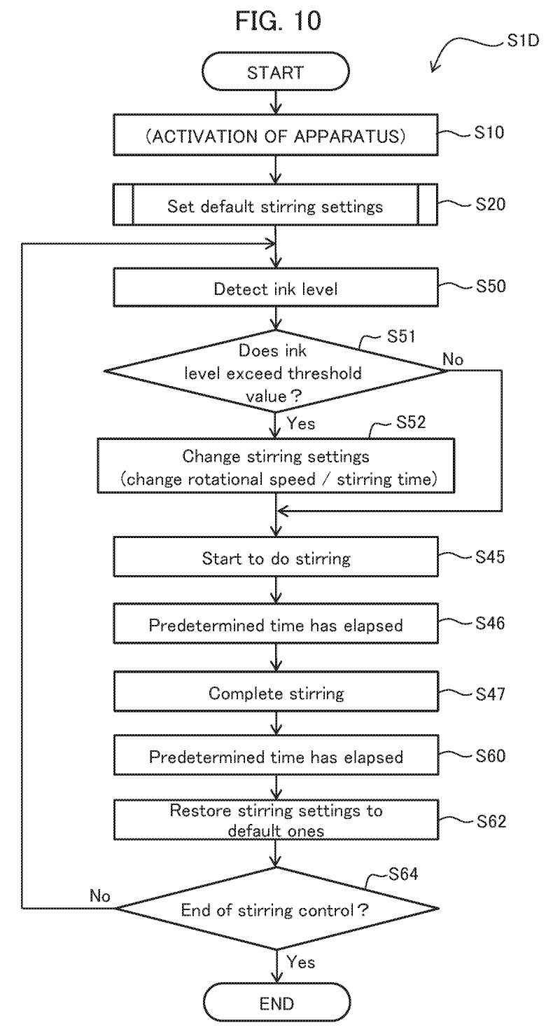

Next, a description is given of a flowchart S1D of a stirring process when the ink leve is detected, with reference to FIG. 10. The flowchart S1D in FIG. 10 corresponds to the third modification. First, once the image forming apparatus 1 has been activated (step S10), the stirring controller 36 sets default stirring settings (step S20).

Subsequently, the stirring controller 36 detects an ink level of the ink tank 51 (step S50). When the ink level exceeds the threshold value (Yes in step S51), the stirring controller 36 changes stirring settings (step S52) and starts to do stirring (step S45). Note that the stirring settings are the rotational speed and stirring time of stirring, and can be set to values different from those when the ink temperature is detected. When the ink level exceeds the threshold value (No in step S51), the stirring controller 36 does not change stirring settings and starts to do stirring with the default stirring settings (step S45). Note that when determining whether or not the ink level is less than or equal to the threshold value (step S41), the stirring controller 36 preferably repeats measuring the ink level more than once and then makes the determination.

The stirring controller 36 executes stirring with the changed stirring settings or the default stirring settings, and when a predetermined stirring time has elapsed (step S46), restores stirring settings to the default stirring settings (step S62). When the stirring control is to be continuied (No in step S64), processing returns to and repeats detecting the ink level in step S50. When the stirring control is to be ended (Yes in step S64), the process in FIG. 10 ends.

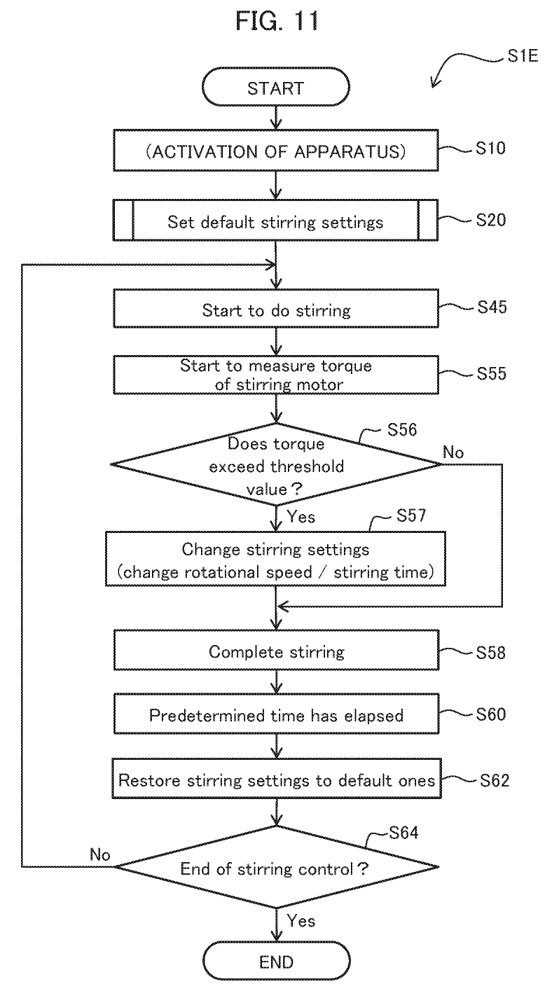

Next, a description is given of a flowchart S1E of a stirring process when the stirring torque is detected, with reference to FIG. 11. The flowchart S1E in FIG. 11 corresponds to the fifth modification. First, once the image forming apparatus 1 has been activated (step S10), the stirring controller 36 sets default stirring settings (step S20), starts to do stirring (step S45), and starts measuring the torque of the stirring motor 522 (step S55). When the torque is less than or equal to a predetermined threshold value (No in step S56), the stirring controller 36 continues to do stirring until the stirring time of the default stirring settings elapses. When the torque exceeds the predetermined threshold value (Yes in step S56), the stirring controller 36 changes stirring settings (step S57), and executes stirring until the stirring time of the changed stirring settings elapses.

When the stirring with the default stirring setting or the changed stirring setting is completed (step S58), the stirring controller 36 restores stirring settings to the default ones (step S62) after a predetermined time set as a time interval until the next stirring has elapsed (step S60). When continuing the stirring control (No in step S64), the stirring controller 36 returns to and repeats a step of starting to do stirring (step S45). When the stirring control is to be ended (Yes in step S64), the process in FIG. 11 ends.

### Second Embodiment

Next described is an image forming apparatus 2 according to a second embodiment. The second embodiment is different from the first embodiment on the point that the ink is delivered with delivery settings based on the state of the ink in the ink tank 51 and the ink is stirred with the normal stirring settings, and is the same as the first embodiment on other points. Note that the state of ink is viscosity, for example, which changes depending on the temperature of ink, a standing time, the color of ink, and the like. In the case of the image forming apparatus 2, the ink delivery controller 37 controls delivering the ink to the ink delivery unit 60 with ink delivery settings based on the state of the ink in the ink tank 51.

For example, when the temperature of ink in the ink tank 51 is at or below a predetermined threshold value for a predetermined time, the ink delivery controller 37 changes the ink delivery settings to those suitable for ink having high viscosity due to decrease in temperature. Changing the ink delivery settings means tentatively changing ink delivery settings already set as the normal ink delivery settings. The normal ink delivery settings are those taken over from the last operation, or those set as default ones at the time of activation of the image forming apparatus 2 or the like.

Here, the supply pump 61 is air-driven and can increase the amount of ink delivered per unit time by increasing air pressure . The ink delivery settings are one or more settings of an air pressure of the supply pump 61 of the ink delivery unit 60 and/or an ink delivery time. The ink delivery time is a time during which the supply pump 61 is driven and the valve 62 stays open, to continue to deliver the ink. When the ink in the ink tank 51 has high viscosity, for example, the image forming apparatus 2 can compensate for decrease in the delivered amount due to the high viscosity, by increasing the air pressure or extending the ink delivery time. Note that increasing both the air pressure and the ink delivery time may result in excessive delivery amount and thus one of them may be increased. When the air pressure is increased and the ink delivery time is extended, the ink delivery settings should be set in consideration of avoiding overflow in the sub-tank 22.

The ink delivery controller 37 may change ink delivery settings when the temperature of the ink in the ink tank 51 is at or below a predetermined threshold value for a predetermined time. Alternatively, the ink delivery controller 37 may change the ink delivery settings when the temperature of the ink in the ink tank 51 at the time of activation is at or below a predetermined threshold value. The ink delivery controller 37 may change the ink delivery settings when the ambient air temperature is at or below a predetermined threshold value. The ink delivery controller 37 can change the ink delivery settings based on the color of ink in the ink tank 51. The ink delivery controller 37 can also set ink delivery settings, for a case where the color of ink in the ink tank 51 is white, to be different from a case where the color of ink in the ink tank 51 is other than white.

The image forming apparatus 2 according to the second embodiment can prevent failure in delivering ink from occurring due to high viscosity, to improve profitability and quality in forming images. In some cases, an inkjet-based image forming apparatus may use UV ink which is cured by ultraviolet rays (UV). The UV ink significantly varies in viscosity due to difference in temperature. The change in viscosity tends to be low viscosity at hot temperature and high viscosity at cold temperature, to have a problem, especialy at low temperature, that an amount of ink delivered by the ink delivery pump decreases due to increase in viscosity. The image forming apparatus 2 can increase the amount of ink to be delivered to the ejection part 21 by increasing the air pressure of the supply pump 61 or extending the ink delivery time, to compensate for decrease in the amount of delivered ink. Noe that the ink delivery settings can be set separately for each of the ink tanks 51.

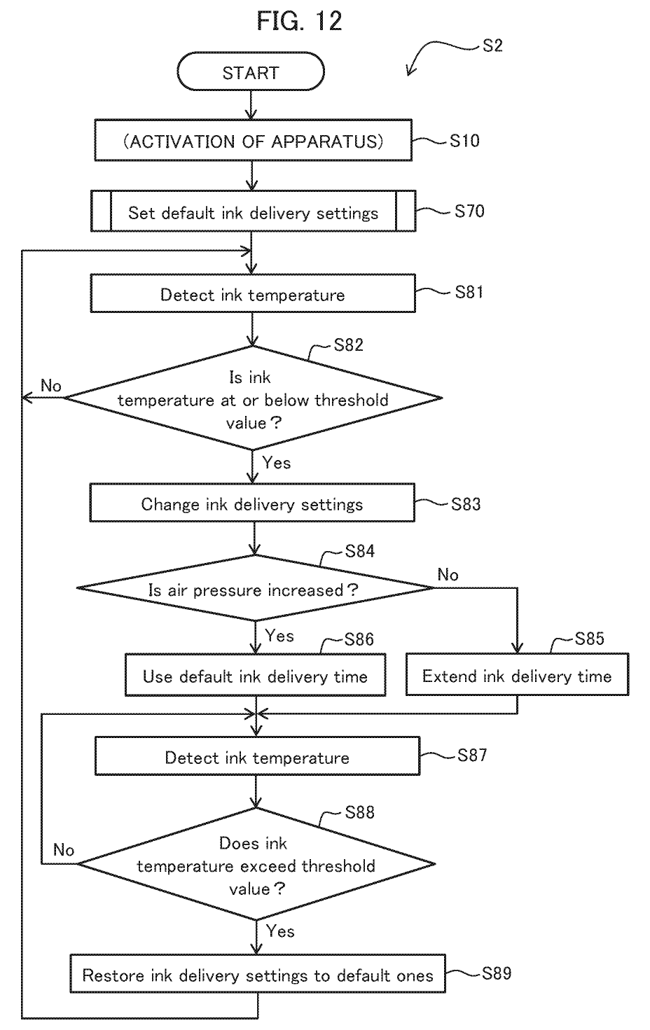

Next, a description is given of a flowchart S2 of a process of delivering ink in the ink tank in the case of the image forming apparatus 2, with reference to FIG. 12. FIG. 12 is a flowchart of the process, when the temperature of ink, as an indicator of the state of ink in the ink tank 51, is detected with the main thermometer 53. First, once the image forming apparatus 2 is activated (step S10), the ink delivery controller 37 sets default ink delivery settings (step S70). Step S70 is described below. Step S70 can be skipped, and when skipped, the default settings at the last operation is inherited. Note that stirring is executed after activation by the stirring controller 36, although not shown in FIG. 12.

The ink delivery controller 37 detects the ink temperature with the main thermometer 53 (step S81), and repeats a step of detecting the ink temperature with the main thermometer 53 (step S81) when the temperature of ink is not at or below the threshold value (No in step S82). Note that the temperature is preferably determined as not being at or below the predetermined threshold value when the detected temperature exceeds a predetermined threshold value for a predetermined time. When the ink temperature is detected as being at or below the threshold value (Yes in step S82), the ink delivery controller 37 changes ink delivery settings (step S83). Here, the ink delivery setting is one of the ink delivery time and air pressure of the supply pump 61, and is determined in the subsequent processing. When increasing the air pressure of the supply pump 61 (Yes in step S84), the ink delivery controller 37 does not change the ink delivery time and uses the default ink delivery time (step S86). When the air pressure is not increased (No in step S84), the ink delivery controller 37 sets an extended ink delivery time (step S85).

The ink delivery controller 37 detects the ink temperature with the main thermometer 53 (step S87), and when the ink temperature exceeds the threshold value (Yes in step S88), restores ink delivery settings to the default ones (step S89), returns to step S81, and detects the ink temperature with the main thermometer. When the ink temperature does not exceed the threshold value (No in step S88), the ink delivery controller 37 continues to use the changed ink delivery settings, returns to step S87 and repeats detecting the ink temperature with the main thermometer. Note that the ink delivery controller 37 delivers ink to the sub-tank 22, in response to a request for delivering ink, with ink delivery settings at that time.

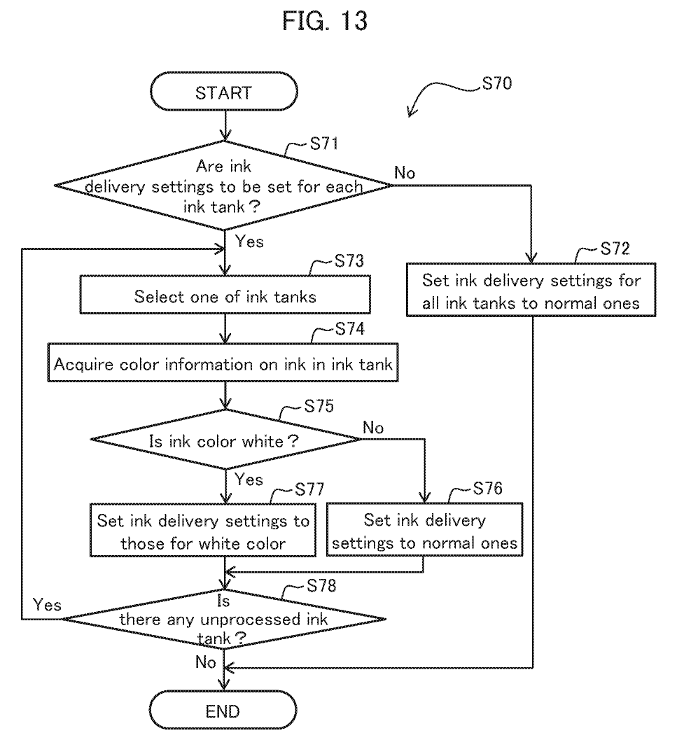

Next, a description is given of a flowchart of setting the default ink delivery settings (step S70), with reference to FIG. 13. FIG. 13 is an example of a process of changing ink delivery setting when the ink color is white, while using the normal ink delivery settings for the other colors. First, the ink delivery controller 37 checks whether or not to set ink delivery settings for each ink tank, and when the result is negative (No in step S71), sets the normal ink delivery settings for all the ink tanks (step S72), and ends the process in FIG. 13.

When ink delivery settings are to be set for each ink tank (Yes in step S71), the ink delivery controller 37 selects one of the ink tanks 51 (step S73) and acquires color information on the ink tank 51 (step S74). The ink delivery controller 37 sets ink delivery settings to those for white (step S77) when the ink color is white (Yes in step S75), and to the normal ink delivery settings (step S76) when the ink color is other than white (No in step S75). This is repeated until there is no more unprocessed ink tanks 51 (step S78), and the process in FIG. 13 ends.

Note that the second embodiment can be combined with one or more of the first embodiment and the modifications. If stirring and ink delivery settings are fixed to those anticipated for high viscosity due to a low temperature, as with the image forming apparatus of the related art, this may cause adverse effects such as decrease in productivity due to extension of the stirring time and the ink delivery time, influence on deaeration due to excessive foaming, and overflow of the ink due to excessive ink delivery. The second embodiment, when combined with the first embodiment and the modifications, that is, executing control to change stirring conditions as well as ink delivery settings, based on the state of the ink, allows for setting the rotational speed of the stirring motor, the stirring time, the amount of ink delivery, and the like more suitably, depending on the color and temperature of the ink in the ink tank, the ink level of the ink tank, the standing time, and the like. This further stabilizes the stirring and ink delivery, to improve quality of forming images.

### CONTROL METHOD

A control method according to the embodiment is a method of causing an image forming apparatus to operate as the image forming apparatus according to the embodiment. The control method is a method of controlling an image forming apparatus including an ink tank that stores ink to be delivered to an inkjet head, and a stirrer that stirs the ink in the ink tank, the method including a step of a stirring controller controlling the stirrer with stirring settings based on temperature and/or color of the ink in the ink tank.

Alternatively, a control method is a method of contyrolling an image forming apparatus including an ink tank that stores ink to be delivered to an inkjet head, and an ink delivery unit that delivers ink from the ink tank to the inkjet head, the method including a step of an ink delivery controller controlling the ink delivery unit to deliver ink with ink delivery settings based on temperature and/or color of ink in the ink tank.

### ADVANTAGEOUS EFFECTS OF EMBODIMENTS

The present invention provides an image forming apparatus that changes settings for stirring and ink delivery settings based on a state of ink in an ink tank to stabilize stirring and ink delivery of ink, and a control method of the same.

Although the embodiments of the present invention have been described and illustrated in detail, the disclosed embodiments are made for the purpose of illustration and exemplification only, and not for limitation The scope of the present invention should be interpreted by terms of the appended claims.

### DESCRIPTION OF REFERENCE SIGNS

1: image forming apparatus, 10: feed unit, 20: image forming unit, 21: ejection part, 22: sub-tank, 23: inkjet head, 24: heater, 25: sub-thermometer, 30: control unit, 35: ink supply control unit, 36: stirring controller, 37: ink delivery controller, 38: heating controller, 40: output unit, 50: reservoir, 51: ink tank, 52: stirrer, 521: stirring screw, 522: stirring motor, 53: main thermometer, 60: ink delivery unit, and 80: operation unit.

What is claimed is:

1. An image forming apparatus comprising:
an ink tank that stores ink to be delivered to an inkjet head;
a stirrer that stirs the ink in the ink tank; and
a stirring controller that controls the stirrer to stir the ink with stirring settings based on a state of the ink in the ink tank.

2. The image forming apparatus according to claim 1, further comprising:
a means to detect a temperature,
wherein the stirring controller changes stirring settings when a detected temperature is at or below a predetermined threshold value.

3. The image forming apparatus according to claim 2, wherein
the stirring controller changes stirring settings when the detected temperature is at or below the predetermined threshold value for a predetermined time.

4. The image forming apparatus according to claim 2, further comprising:
a main thermometer that detects a temperature of the ink in the ink tank,
wherein the stirring controller changes stirring settings, based on a temperature of the ink in the ink tank.

5. The image forming apparatus according to claim 2, wherein
a sub-tank having a sub-thermometer to detect a temperature of the ink is provided downstream of the ink tank, and
the stirring controller changes stirring settings, based on a temperature of the ink in the sub-tank.

6. The image forming apparatus according to claim 2, further comprising:
an ambient air thermometer that detects a temperature of ambient air,
wherein the stirring controller changes stirring settings, based on the temperature of ambient air.

7. The image forming apparatus according to claim 1, further comprising:
an ink level detector that detects an ink level of the ink tank;
wherein the stirring controller changes stirring settings, based on the ink level of the ink tank detected by the ink level detector.

8. The image forming apparatus according to claim 1, wherein
the stirring controller calculates a standing time, during which the ink has not been stirred, and changes stirring setting when the standing time exceeds a predetermined length.

9. The image forming apparatus according to claim 1, wherein
the stirring controller changes stirring settings, based on color of the ink in the ink tank.

10. The image forming apparatus according to claim 9, wherein
the stirring controller, when the color of the ink in the ink tank is white, sets different stirring settings from those when the color of the ink in the ink tank is other than white.

11. The image forming apparatus according to claim 1, wherein
the stirring controller changes stirring setting for stirring immediately after activation.

12. The image forming apparatus according to claim 1, further comprising:
an ink delivery unit that delivers the ink from the ink tank to the inkjet head; and
an ink delivery controller that controls the ink delivery unit to deliver ink with ink delivery settings based on a state of the ink in the ink tank.

13. The image forming apparatus according to claim 12, further comprising:
a means to detect a temperature,
wherein the ink delivery controller changes ink delivery settings when a detected temperature is at or below a predetermined threshold value.

14. The image forming apparatus according to claim 13, wherein
the ink delivery controller changes ink delivery settings when the detected temperature is at or below the predetermined threshold value for a predetermined time.

15. The image forming apparatus according to claim 13, further comprising:
a main thermometer that detects a temperature of the ink in the ink tank,
wherein the ink delivery controller changes ink delivery settings, based on a temperature of the ink in the ink tank.

16. The image forming apparatus according to claim 13, wherein
a sub-tank having a sub-thermometer to detect a temperature of the ink is provided downstream of the ink tank, and
the ink delivery controller changes ink delivery settings, based on a temperature of the ink in the sub-tank.

17. The image forming apparatus according to claim 13, further comprising:
an ambient air thermometer that detects a temperature of ambient air,
wherein the ink delivery controller changes ink delivery settings, based on the temperature of ambient air.

18. The image forming apparatus according to claim 12, wherein
the ink delivery controller changes ink delivery settings, based on color of the ink in the ink tank.

19. A control method of an image forming apparatus including: an ink tank that stores ink to be delivered to an inkjet head; and a stirrer that stirs the ink in the ink tank, the method comprising:
controlling the stirrer to stir the ink with stirring settings based on a state of the ink in the ink tank.

20. A control method of an image forming apparatus including: an ink tank that stores ink to be delivered to an inkjet head; and an ink delivery unit that delivers the ink from the ink tank to the inkjet head, the method comprising:
controlling the ink delivery unit to deliver the ink with ink delivery settings based on a state of the ink in the ink tank.
